(19) United States
(12) Patent Application Publication
(10) Pub. No.: US 2009/0245489 A1
(43) Pub. Date: Oct. 1, 2009

(54) AUTOMATED SYSTEM FOR SOLICITING CHARITABLE DONATIONS

(75) Inventors: Matthew M. Frazier, Fairview, TX (US); Johnross M. Miller, Dallas, TX (US)

Correspondence Address: MICHAEL A. O'NEIL, P.C., 5949 SHERRY LANE, SUITE 820, DALLAS, TX, 75225, US

(73) Assignee: THE PURSUANT GROUP, Plano, TX (US)

(21) Appl. No.: 12/413,325

(22) Filed: Mar. 27, 2009

Related U.S. Application Data
(60) Provisional application No. 61/040,176, filed on Mar. 28, 2008.

(51) Int. Cl. H04M 11/00; G06Q 20/00; G06Q 50/00

(52) U.S. Cl. 379/93.12; 705/40; 705/34

(57) ABSTRACT

A method of telephone soliciting charitable contributions comprises identifying prior contributors to or members of an entity desiring funding, identifying a telephone number associated with each prospective contributor, creating a series of suggested donations each associated with a specific touch tone telephone key, creating a recorded contribution solicitation including suggested donation amounts and the touch tone telephone key associated with each suggested amount, placing a telephone call comprising the recorded contribution solicitation to each identified prospective contributor to the entity, and charging a selected contribution amount to the telephone bill associated with the contributor that responded to the recorded contribution solicitation.

### CROSS-REFERENCE TO RELATED APPLICATION

Applicants claim priority based on U.S. Provisional Patent Application No. 61/040,176 filed Mar. 28, 2008, the entire content of which is incorporated herein by reference.

### DESCRIPTION OF THE DRAWINGS

FIG. 1 is a flowchart illustrating a first embodiment of the invention;

FIG. 2 is flowchart illustrating a second embodiment of the invention; and

FIG. 3 is a flowchart illustrating a third embodiment of the invention.

### DETAILED DESCRIPTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

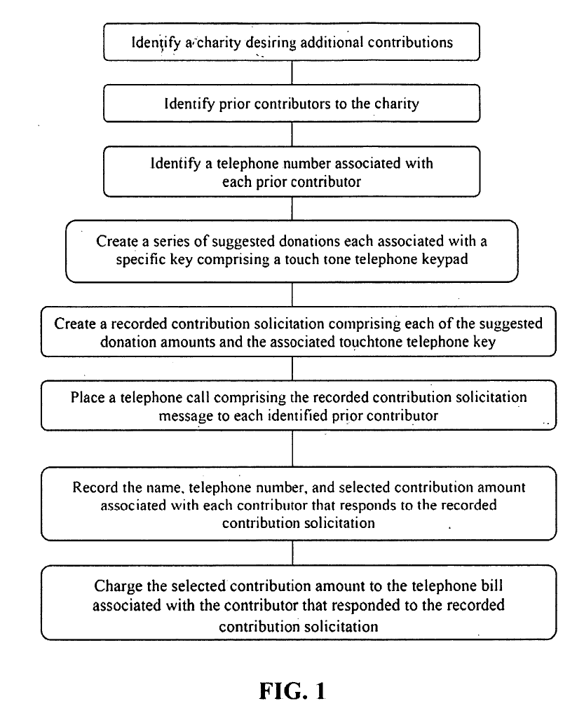

Referring to FIG. 1, a method of soliciting charitable contributions is disclosed. The first step in the method comprises identification of a charity desiring additional contributions. When a particular charity desiring additional contributions has been identified a list of prior contributors to the charity is prepared. The list of prior contributors to the charity includes or is revised to include a telephone number associated with each prior contributor.

The identified charity also creates a list of suggested contributions. Each of the suggested contributions is identified with one of the keys comprising a touch tone telephone keypad. Because a conventional touch tone telephone keypad includes 12 keys, up to 12 suggested donations can be included in the list thereof.

Once the list of suggested donations has been created the identified charity creates a recorded contribution telephone solicitation including each of the donation amounts comprising the list and the associated touch tone telephone key.

When the recorded contribution telephone solicitation has been completed to the satisfaction of the identified charity telephone calls are place to the prior contributors to the charity. At the conclusion of each telephone call a record is made of the name, telephone number, and selected contribution amount associated with each prior contributor to the charity that has affirmatively responded to the telephone solicitation. The selected contribution amount is then automatically charged to the telephone bill associated to the prior contributor to the charity that affirmatively responded to the recorded contribution telephone solicitation.

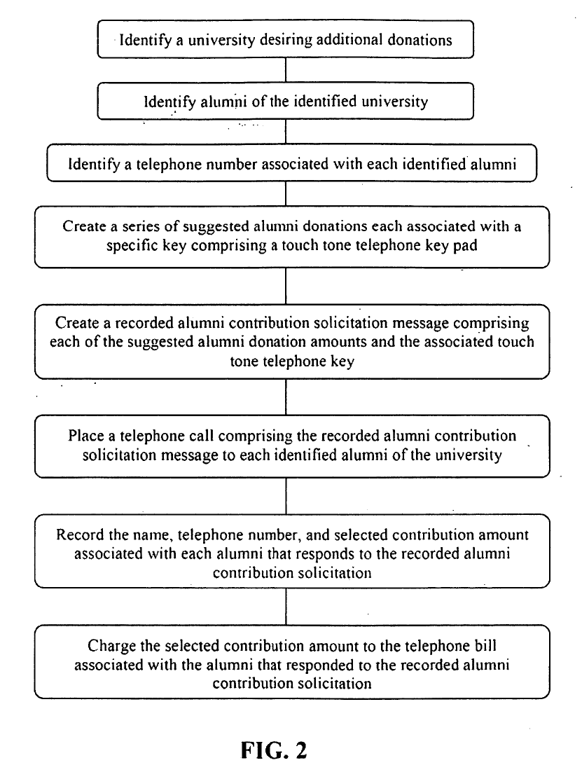

Referring to FIG. 2, method of soliciting charitable contributions form university alumni is disclosed. The first step in the method comprises identification of a university desiring additional contributions. When a particular university desiring additional contributions has been identified a list of alumni of the university is prepared. The list of alumni includes or is revised to include a telephone number associated with each alumnus.

The identified university also creates a list of suggested contributions. Each of the suggested contributions is identified with one of the keys comprising a touch tone telephone keypad. Because a conventional touch tone telephone keypad includes 12 keys up to 12 suggested donations can be included in the list thereof.

Once the list of suggested donations has been created, the identified university creates a recorded contribution telephone solicitation including each of the donation amounts comprising the list and the associated touch tone telephone key.

When the recorded contribution telephone solicitation has been completed to the satisfaction of the identified university telephone calls are place to the alumni of the university. At the conclusion of each telephone call a record is made of the name, telephone number, and selected contribution amount associated with each alumni of the university that has affirmatively responded to the telephone solicitation. The selected contribution amount is then automatically charged to the telephone bill associated with the alumni of the university that affirmatively responded to the recorded contribution telephone solicitation.

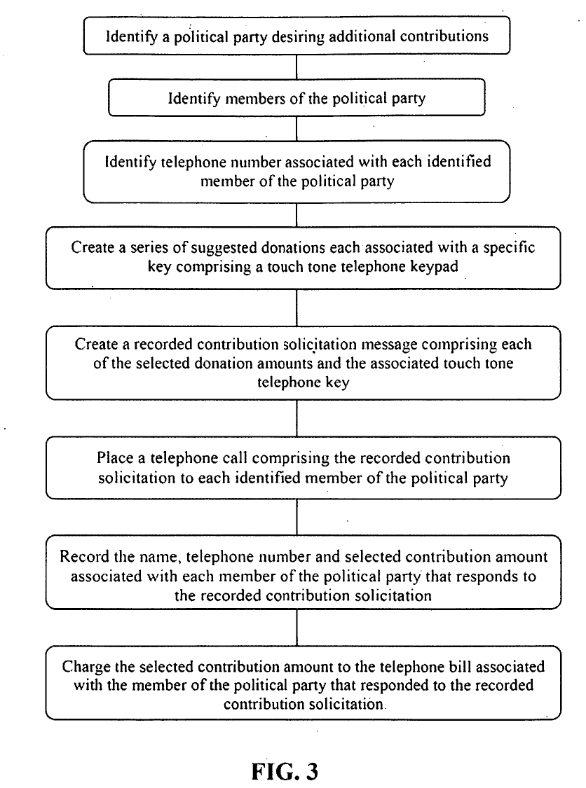

Referring to FIG. 3, method of soliciting contributions to a political party is disclosed. The first step in the method comprises identification of a political party desiring additional contributions. When a particular political party desiring additional contributions has been identified a list of prior contributors to the political party is prepared. The list of prior contributors to the political party includes or is revised to include a telephone number associated with each prior contributor.

The identified political party also creates a list of suggested contributions. Each of the suggested contributions is identified with one of the keys comprising a touch tone telephone keypad. Because a conventional touch tone telephone keypad includes 12-keys, up to 12 suggested donations can be included in the list thereof.

Once the list of suggested donations has been created, the identified political party creates a recorded contribution telephone solicitation including each of the donation amounts comprising the list and the associated touch tone telephone key.

When the recorded contribution telephone solicitation has been completed to the satisfaction of the identified political party telephone calls are place to the prior contributors to the political party. At the conclusion of each telephone call a record is made of the name, telephone number, and selected contribution amount associated with each prior contributor to the political party that has affirmatively responded to the telephone solicitation. The selected contribution amount is then automatically charged to the telephone bill associated to the prior contributor to the political party that affirmatively responded to the recorded contribution telephone solicitation.

Although preferred embodiments of the invention have been illustrated in the accompanying Drawings and described in the foregoing Detailed Description, it will be understood that the invention is not limited to the embodiments disclosed, but is capable of numerous rearrangements, modifications and substitutions of parts and elements without departing from the spirit of the invention.

1. A method of soliciting charitable contributions comprising the steps of:
identifying a charity desiring contributions;
identifying prior contributors to the charity;
identifying a telephone number associated with each identified prior contributor to the charity;
creating a series of suggested donations each associated with a specific key comprising a touch tone telephone keypad;
creating a recorded contribution solicitation comprising each of the suggested donation amounts and the associated touch tone telephone key;
placing a telephone call comprising the recorded contribution solicitation to each identified prior contributor to the charity;
recording the name, telephone number, and selected contribution amount associated with each contributor that responds to the recorded contribution solicitation; and
charging the selected contribution amount to the telephone bill associated with the contributor that responded to the recorded contribution solicitation.

2. A method of soliciting charitable contributions comprising the steps of:
identifying a university desiring contributions;
identifying alumni of the university;
identifying a telephone number associated with each identified alumni of the university;
creating a series of suggested donations each associated with a specific key comprising a touch tone telephone keypad;
creating a recorded contribution telephone solicitation comprising each of the suggested donation amounts and the associated touch tone telephone key;
placing a telephone call comprising the recorded contribution solicitation to each identified alumni of the university;
recording the name, telephone number, and selected contribution amount associated with each alumni that responds to the recorded contribution solicitation; and
charging the selected contribution amount to the telephone bill associated with the alumni that responded to the recorded contribution solicitation.

3. A method of soliciting charitable contributions comprising the steps of:
identifying a political party desiring contributions;
identifying prior contributors to the political party;
identifying a telephone number associated with each identified prior contributor to the political party;
creating a series of suggested donations each associated with a specific key comprising a touch tone telephone keypad;
creating a recorded contribution telephone solicitation comprising each of the suggested donation amounts and the associated touch tone telephone key;
placing a telephone call comprising the recorded contribution solicitation to each identified prior contributor to the political party;
recording the name, telephone number, and selected contribution amount associated with each contributor that responds to the recorded contribution solicitation; and
charging the selected contribution amount to the telephone bill associated with the contributor that responded to the recorded contribution solicitation.
